(19) United States
(12) Patent Application Publication
(10) Pub. No.: US 2016/0204501 A1
(43) Pub. Date: Jul. 14, 2016

(54) CLOSELY COUPLED RE-RADIATOR COMPOUND LOOP ANTENNA STRUCTURE

(71) Applicant: DockOn AG, Zurich (CH)

(72) Inventors: Jonathan Neil BRINGUIER, Carlsbad, CA (US); Eugene Yu-Giun REN, San Marcos, CA (US); Nan XU, San Diego, CA (US)

(21) Appl. No.: 15/055,363

(22) Filed: Feb. 26, 2016

Related U.S. Application Data
(63) Continuation-in-part of application No. 14/712,804, filed on May 14, 2015.
Application No. 14/712,804 is a continuation-in-part of application No. 14/103,684, filed on Dec. 11, 2013.
Application No. 14/103,684 is a continuation-in-part of application No. 14/565,379, filed on Dec. 9, 2014.
(60) Provisional application No. 62/126,373, filed on Feb. 27, 2015.
(60) Provisional application No. 61/996,773, filed on May 14, 2014.
(60) Provisional application No. 61/913,789, filed on Dec. 9, 2013.

(51) Int. Cl. H01Q 1/24; H04B 5/00

(52) U.S. Cl. CPC H01Q 1/243; H04B 5/0087

(57) ABSTRACT

Source radio frequency energy (RF) is coupled wirelessly (no physical contact) between two compound loop (CPL) antennas or one CPL and another type of antenna across a variety of barriers such as plastic, human tissues, glass, and air. The compound coupling interface created between the two antennas is highly efficient in transferring the RF energy from a source antenna to a destination including a CPL antenna. A re-radiating structure including a further CPL antenna or a different type of antenna may be connected on the destination side to completely physically isolate the source side from the destination side. When the destination coupling antenna is removed, the source coupling antenna may operate as an efficient radiator at the desired operating frequencies. Likewise, the destination coupling antenna may operate as an efficient radiator in the absence of the source coupling antenna.

### CROSS REFERENCE TO RELATED APPLICATIONS

This application claims benefit under 35 U.S.C. §119(e) of Provisional U.S. Patent Application No. 62/126,373, filed Feb. 27, 2015. This application is also a continuation-in-part of U.S. patent application Ser. No. 14/712,804, filed May 14, 2015, which claims benefit under 35 U.S.C. §119(e) of Provisional U.S. Patent Application No. 61/996,773, filed May 14, 2014, and which is a continuation-in-part of U.S. patent application Ser. No. 14/103,684, filed Dec. 11, 2013; and a continuation-in-part of U.S. patent application Ser. No. 14/565,379, filed Dec. 9, 2014, which claims the benefit of Provisional U.S. Patent Application No. 61/913,789, filed Dec. 9, 2013, the contents of each of which are incorporated herein by reference in their entirety.

### FIELD OF THE DISCLOSURE

This disclosure is related to wireless transmission and reception antennas and related structures.

### BACKGROUND

There are many cases where a radio transceiver needs to be physically located in an environment that is non-ideal for electromagnetic wave propagation, such as below ground level water utility metering pits. Radio signals that are generated from below ground level in such environments are often absorbed, refracted, and reflected, resulting in poor radio frequency (RF) propagation. When the pit structure includes a metal lid, RF propagation may be even more impacted. For fixed water utility metering networks that are comprised of radio transceivers located in the ground attached to water meters, and base station receivers located on buildings and towers, poor RF propagation can result in significant cost increases as some meters cannot be read (unless manually) and some can only be read remotely if more base stations are installed. When more base stations are required to supply adequate network coverage, the meter transceivers' transmit power levels often need to be increased, which in turn reduces battery life or requires additional batteries to be included at significant cost, impacting corporate profits significantly.

One solution to mitigating poor RF propagation environments, such as the below ground water pit example, is to transfer the RF energy from the radio transceiver below ground to a radiating structure located above ground, which is a much more suitable RF propagation environment. In addition, the physical environment of the water pit example above requires the meter transceiver and associated electronics to be completely hermetically sealed to guarantee a meaningful operating life (e.g., 20 years) and maintain a barrier for water vapor that destroys the electronics over time. Because of this constraint, no physical contacts may be used to transfer the RF energy from the meter transceiver located below ground, to the above ground radiating structure, such as cables or contact connectors.

In another example, in order to meet consumer demand or to obtain first to market advantage, products are often first commercialized and launched before an optimized antenna design for the device has been finalized. In such cases, the antenna over the air (OTA) or RF emission performance of the product can still be improved. With improved OTA and/or reduced radiated spurious emission (RSE), users can benefit from higher speeds when transmitting or receiving data, more reliable wireless connections, and less harmful RF radiation. However, once a product has been built, replacing or otherwise changing the internal antenna is not practical.

In a further example, antennas mounted within certain wireless devices may also have poor RF propagation or reception. For example, antennas mounted within the body of a cellular phone or smart phone may be impacted by the placement or position of a user's hand holding the phone during use. In the past, many devices were designed with antennas that extended away from the body of the phone, but modern design esthetics requires the antennas to be hidden away within the device where the antennas are also subject to RF from other components and extremely challenging space limitations, especially when many devices are expected to operate at multiple frequencies.

### BRIEF DESCRIPTION OF THE DRAWINGS

FIG. 1 is a side view of a water meter connected to a compound coupled transmitter assembly in accordance with an embodiment;

FIG. 2 is a perspective view of an embodiment of a below ground electrical device assembly having a half wave compound loop (CPL) antenna wirelessly coupled to a half wave CPL antenna of an above-ground re-radiator assembly having a different type of antenna performing re-radiation;

FIG. 3 is a more detailed, perspective view of an embodiment of a re-radiator assembly similar to that of FIG. 2 with a different type of antenna performing compound coupling;

FIG. 4 is a perspective view illustrating the coupling interface between the below ground electrical device assembly and the re-radiator assembly;

FIG. 5 is a perspective view of an embodiment of a re-radiator assembly having a capacitively coupled CPL (C2CPL) antenna;

FIG. 6 is a perspective view illustrating the coupling interface between an electrical device assembly and the re-radiator assembly of FIG. 5;

FIG. 7 is a perspective view of the electrical device assembly and re-radiator assembly of FIG. 5 in coupling mode;

FIG. 8 is a top view of an embodiment of a full wave CPL antenna;

FIG. 9 is a perspective view of an embodiment of two full wave CPL antennas in a couple arrangement;

FIG. 10 is a perspective view of an embodiment of two full wave CPL antennas coupling through a glass medium;

FIG. 11 is a perspective view of an embodiment of a printed CPL antenna on a PCB coupled to a second printed CPL antenna on a separate assembly, where the second CPL antenna is connected to a third CPL antenna the re-radiates the RF energy from the first antenna;

FIG. 12 is exploded view of an embodiment of a smartphone and a case for the smartphone including two CPL antennas for re-radiating energy from original antennas of the smartphone;

FIG. 13 is a perspective view of the inner portion of the case mounted on the smartphone and the two CPL antennas applied to the inner portion;

FIG. 14 is an illustration of a top view of the 700 MHz free space radiation pattern of the smartphone without the re-radiator structure;

FIG. 15 is an illustration of a top view of the 700 MHz free space radiation pattern of the smartphone with the re-radiator structure;

FIG. 16 is an illustration of a top view of the 700 MHz radiation pattern of the smartphone with the re-radiator structure when the smartphone is held in the user's right hand;

FIG. 17 is an illustration of a side view of the 700 MHz radiation pattern of the smartphone with the re-radiator structure when the smartphone is held in the user's right hand;

FIG. 18 is an illustration of a top view of the 1700 MHz free space radiation pattern of the smartphone without the re-radiator structure;

FIG. 19 is an illustration of a top view of the 1700 MHz free space radiation pattern of the smartphone with the re-radiator structure;

FIG. 20 is an illustration of a side view of the 1700 MHz radiation pattern of the smartphone without the re-radiator structure when the smartphone is held in the user's right hand; and

FIG. 21 is an illustration of a side view of the 1700 MHz radiation pattern of the smartphone with the re-radiator structure when the smartphone is held in the user's right hand.

### DETAILED DESCRIPTION OF ILLUSTRATIVE EMBODIMENTS

Wireless communication devices are finding applications that require new antenna designs to address inherent limitations of the devices and to enable new capabilities. With conventional antenna structures, a certain physical volume is required to produce a resonant antenna structure at a particular frequency and with a particular bandwidth. However, effective implementation of such antennas is often confronted with size constraints due to limited available space in the device.

Antenna efficiency is one of the important parameters that determine the performance of the device. In particular, radiation efficiency is a metric describing how effectively the radiation occurs, and is expressed as the ratio of the radiated power to the input power of the antenna. A more efficient antenna will radiate a higher proportion of the energy fed to it. Likewise, due to the inherent reciprocity of antennas, a more efficient antenna will convert more of a received energy into electrical energy. Therefore, antennas having both good efficiency and compact size are often desired for a wide variety of applications.

Conventional loop antennas are typically current fed devices, which generate primarily a magnetic (H) field. As such, they are not typically suitable as transmitters. This is especially true of small loop antennas (i.e., those smaller than, or having a diameter less than, one wavelength). The amount of radiation energy received by a loop antenna is, in part, determined by its area. Typically, each time the area of the loop is halved, the amount of energy which may be received is reduced by approximately 3 dB. Thus, the size-efficiency tradeoff is one of the major considerations for loop antenna designs.

Voltage fed antennas, such as dipoles, radiate both electric (E) and H fields and can be used in both transmit and receive modes. Compound antennas are those in which both the transverse magnetic (TM) and transverse electric (TE) modes are excited, resulting in performance benefits such as wide bandwidth (lower Q), large radiation intensity/power/gain, and good efficiency. There are a number of examples of two dimensional, non-compound antennas, which generally include printed strips of metal on a circuit board. Most of these antennas are voltage fed. An example of one such antenna is the planar inverted F antenna (PIFA). A large number of antenna designs utilize quarter wavelength (or some multiple of a quarter wavelength), voltage fed, dipole antennas.

Compound loop (CPL) antennas are finding applications that are not appropriate for other types of antennas. The CPL antenna includes a loop and a radiator, but may also include multiple radiators or radiating elements that are part of the loop. Similar to a conventional loop antenna, that is typically current fed, the loop element of the CPL antenna may generate a magnetic (H) field. The radiating element, having the series resonant circuit characteristics, effectively operates as an electric (E) field radiator (which of course is an E field receiver as well due to the reciprocity inherent in antennas). In order to operate as a CPL antenna, the generating/receiving E and H fields must be substantially orthogonal to each other, even though the loop and radiator element may be coplanar. This orthogonal relationship has the effect of enabling the electromagnetic waves emitted by the antenna to effectively propagate through space. In the absence of the E and H fields arranged orthogonal to each other, the waves will not propagate effectively beyond short distances. To achieve this effect, the radiating element is generally placed at a position where the E field produced by the radiating element is 90° or 270° out of phase relative to the H field produced by the loop element. Specifically, the radiating element is placed at the substantially 90° (or 270°) electrical length along the loop element from a feed point. Alternatively, the radiating element may be connected to a location of the loop element where current flowing through the loop element is at a reflective minimum.

In addition to the orthogonality of the E and H fields, it is desirable that the E and H fields are comparable to each other in magnitude. These two factors, i.e., orthogonality and comparable magnitudes, may be appreciated by looking at the Poynting vector (vector power density) defined by P=E×H (Volts/m×Amperes/m=Watts/m2). The total radiated power leaving a surface surrounding the antenna is found by integrating the Poynting vector over the surface. Accordingly, the quantity E×H is a direct measure of the radiated power, and thus the radiation efficiency. First, it is noted that when the E and H fields are orthogonal to each other, the vector product gives the maximum. Second, since the overall magnitude of a product of two quantities is limited by the smaller, having the two quantities (|H| and |E| in this case) as close as possible will give the optimal product value. As explained above, in the CPL antenna, the orthogonally is achieved by placing the radiating element at the substantially 90° (or 270°) electrical length along the loop element from a feed point. Furthermore, the shapes and dimensions of the loop element and the radiating element can be each configured to provide comparable, high |H| and |E| in magnitude, respectively. Therefore, in marked contrast to a conventional loop antenna, the CPL antenna, such as a planar CPL antenna, can be configured not only to provide both transmit and receive modes, but also to increase the radiation efficiency.

Size reduction can be achieved by introducing a series capacitance in the loop element and/or the radiating element of the CPL antenna. Such an antenna structure, referred to as a capacitively-coupled compound loop antenna (C2CPL), has been devised to provide both transmit and receive modes with greater efficiency and smaller size than a conventional antenna. Examples of structures and implementations of the C2CPL antennas are described in U.S. patent application Ser. No. 13/669,389, entitled “Capacitively Coupled Compound Loop Antenna,” filed Nov. 5, 2012, which is incorporated herein by reference.

The compound coupling interface described herein is a passive, non-contact system for efficiently transferring the RF energy from one CPL antenna to another CPL antenna, thereby requiring relatively little power and resulting in little dB loss. Rather, the two CPL antennas are both capacitively coupled and inductively coupled at the same time, which is possible due to the unique operating structure of the CPL antenna.

While other wireless antenna coupling designs have been implemented in the past, such designs typically utilize one of two possible simple-field coupling technologies: substantially capacitive coupling or substantially inductive coupling. Capacitive coupling using parallel plates of conductive material is inherently highly sensitive to translation and alignment between the two coupling structures. The coupling areas are maximized along the edges of conductive plates and very slight translations (fractions of a millimeter) can cause frequency shift and significant increases in loss of RF energy. Capacitive coupling is more sensitive to material interactions because of the fringe electric fields along the edges of the conductive plates. These drawbacks have limited the use of capacitive coupling in commercial applications where low coupling loss is desired.

Unlike the compound coupling architecture of the present disclosure, it is also typically not possible to realize a dual mode radiator and a coupler with one artwork. One of the two capacitive plates cannot typically function as both an antenna and a coupler, both at the same frequency of operation.

Inductive coupling using a pair of conductive loops requires a larger aperture, and thus larger volume to implement, than capacitive or compound coupling to achieve low coupling loss. When the pair of inductive loops are realized to be less than a wavelength in circumference (small loops), in order to reduce overall size, the feeding mechanism becomes more critical to maintain low coupling loss. Typically, the small loops are fed with unbalanced feeds and common mode current can interact with the feed, reducing coupling efficiency and increasing RF energy loss.

Unlike the compound coupling architecture of the present disclosure, it is also typically not possible to realize a dual mode radiator and a coupler utilizing inductive coupling with one artwork. One of the two loops cannot typically function as both an antenna and coupler both at the same frequency of operation.

The compound coupling architecture of the present disclosure enables both CPL antennas to simultaneously capactively couple and inductively couple, with relatively high efficiency and relatively little coupling loss. In addition, when the CPL antennas are not being used to couple with one another, either or both CPL antennas can function as a radiator.

Since the two CPL antennas of the compound coupling system do not require any physical connections in order to couple, both CPL antennas and their associated assemblies may be completely sealed, i.e., hermetically sealed, so as to protect the antennas, the associated assembly circuitry, and the re-radiating antenna structure from any type of environmental intrusion, such as water. One particular appropriate application is that of a water meter wireless endpoint. Water lines are typically buried underground. Water meters that measure the flow (and therefore the usage of water) through such lines are usually located in a pit buried in the ground. The pits are typically constructed from rigid plastic or non-corrosive metal and can extend many feet into the ground, with the water pipe running through the bottom of the pit. The top of the pit is flush with the ground surface and is usually covered with a lid. The pits are not water proof, so due to water leaks, high water tables, and run-off from other sources, the pits may be completely flooded. The water meter generates a signal that is output through a sealed cable extending from the meter. The cable typically connects to an electrical device that receives the metered signal from the water meter and transmits the metered signal to a remotely located host station. Merely being buried in the ground is one obstacle to transmitting a strong signal. Interference from surrounding water, the material forming the pit and the material forming the lid can be further factors limiting the efficiency of the transmission of the electrical device in these types of scenarios.

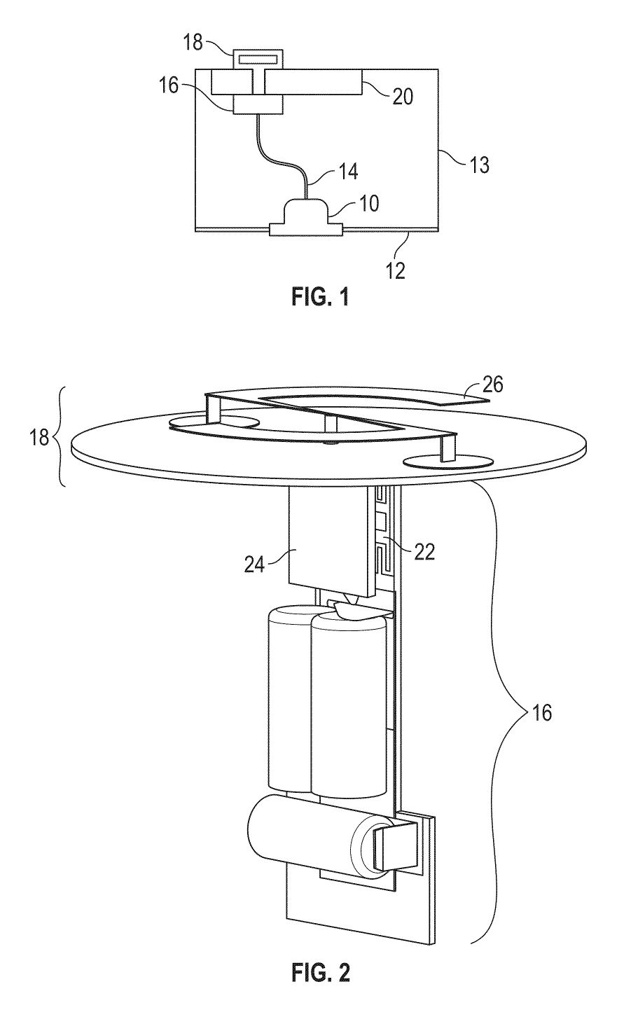

In an embodiment illustrated in FIG. 1, a meter 10 is attached to a pipe 12 within a pit 13. The meter is connected by a cable 14 to a printed circuit board (PCB) assembly 16 containing the electronics necessary to perform some particular function. In other embodiments, the PCB assembly 16 could be integrated with the meter 10 so as to eliminate the need for the cable 14 or the meter 10 could be compound coupled to the PCB assembly in place of the cable 14, as further described below. The PCB assembly 16 is compound coupled to a re-radiating assembly 18 that is installed within and/or on top of the lid 20 to the pit 13.

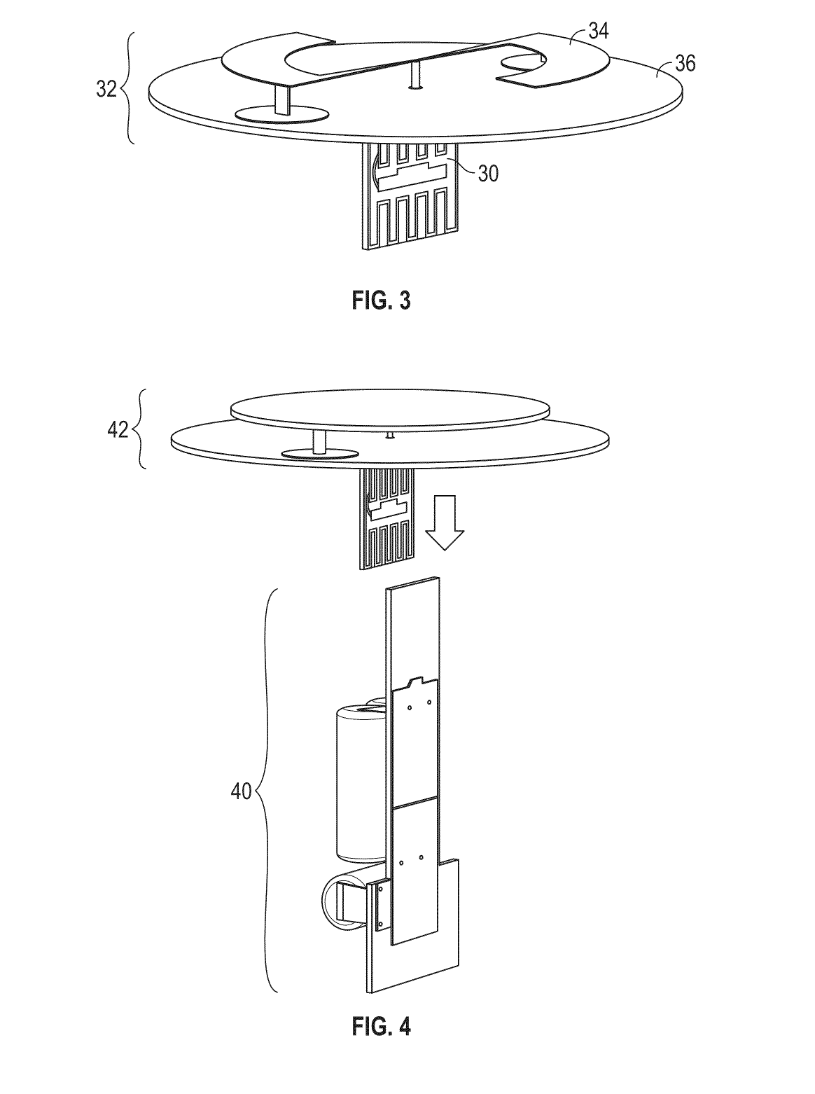

FIG. 2 further illustrates the PCB assembly 16 and the re-radiator assembly 18 of FIG. 1. The PCB assembly 16 may be hermetically sealed inside a plastic enclosure. Inside the enclosure, the assembly 16 includes electronics for receiving and analyzing the metered signal from the meter and sufficient power supplies to operate the assembly for an extended period of time, as many as 10 years, without maintenance or recharging. A compound loop (CPL) antenna 22 may be printed on the PCB of the PCB assembly 16. The CPL antenna 22 may operate as an efficient antenna tuned for the 900 MHz ISM band when no other antenna/coupler structure is present. When CPL antenna 22 cannot achieve sufficient transmission capacity (i.e., distance or reliability) due to interference within the pit 13 or from the lid 20, a re-radiator assemble 18 may be added. The re-radiator assembly 18 may be within a second hermetically sealed plastic enclosure which includes two more compound CPL antennas, CPL antenna 24 (on the opposite side of the PCB shown) and CPL antenna 26. CPL antenna 24 is oriented parallel to CPL antenna 22 so as to be spaced away and not in direct contact. CPL antenna 24 may operate as a an efficient antenna tuned for a particular frequency band, such as the 900 MHz ISM ban, but will also operate as a coupler when placed in close proximity to CPL antenna 22, in which case CPL antenna 22 will also operate as a coupler.

Since the two antennas 22 and 24 are compound loop antennas, which enable simultaneous capacitive coupling and inductive coupling, the coupling arrangement between the two CPL antennas 22 and 24 is referred to herein as “compound coupling.” The two CPL antennas 22 and 24 are placed parallel to each other, but not in direct contact, but still efficiently transfer RF energy from the source of the PCB assembly 16 to the re-radiating CPL antenna 26. When the CPL antennas 22 and 24, which may both be half wave CPL antennas, are configured in close proximity to one another(e.g., about 5 mm), both antennas may operate as efficient wireless compound couplers, transferring RF energy across a boundary of various dielectric material with approximately 1 dB loss. CPL antenna 26 is also located in the second plastic housing. While antenna 26 is described in this embodiment as a low profile, vertically polarized CPL antenna, operating as a re-radiator, the antenna 26 need not be a CPL antenna and other types of antennas could be used in place of a CPL.

FIG. 3 illustrates further details of a different type of CPL antenna 30 of a re-radiator assembly 32, having the same type of re-radiator antenna 34 shown in FIG. 2. In this embodiment, CPL antenna 30 is a C2CPL antenna, as would be the corresponding coupling antenna of the PCB assembly (not shown in FIG. 3). The low profile, vertically polarized CPL antenna 34 is mounted to a finite ground plane shared with the CPL antenna 30. A similar arrangement is used in FIG. 2 as well.

FIG. 4 provides further details regarding the physical orientation required for the compound coupling between the CPL antennas of the PCB assembly 40 and the re-radiator assembly 42.

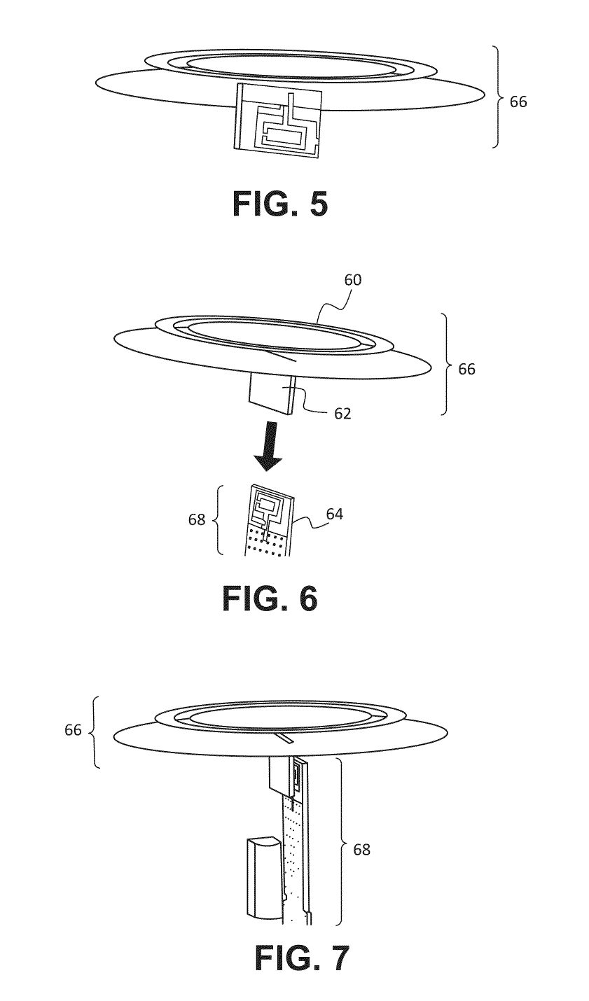

Other examples of a compound coupling to re-radiating antenna solution can be seen in FIGS. 5, 6 and 7, where the pair of compound coupling CPL antennas are implemented using varying loop wavelength architectures. For example, FIG. 6 is a perspective view illustrating a passive re-radiating component 60 of a C2CPL 62 to C2CPL 64 compound coupled system, with FIG. 5 providing some details regarding the re-radiator assembly 66, and FIG. 7 providing details of the operating arrangement between the re-radiator assembly 66 of FIG. 5 and the PCB assembly 68.

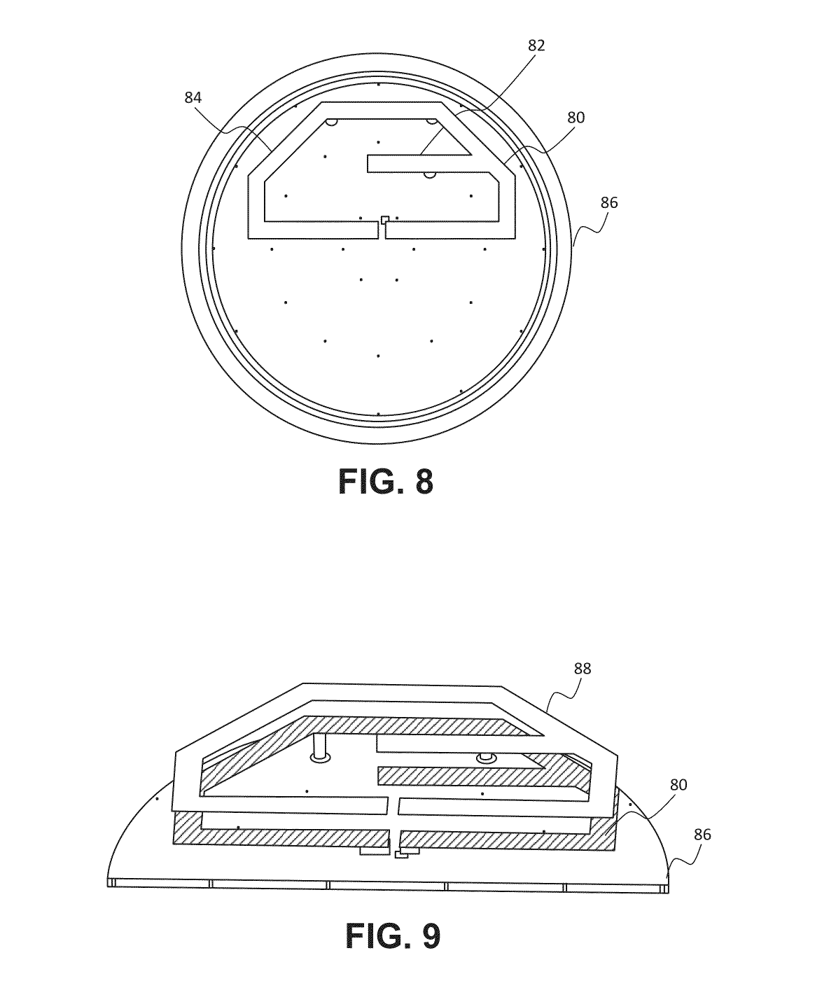

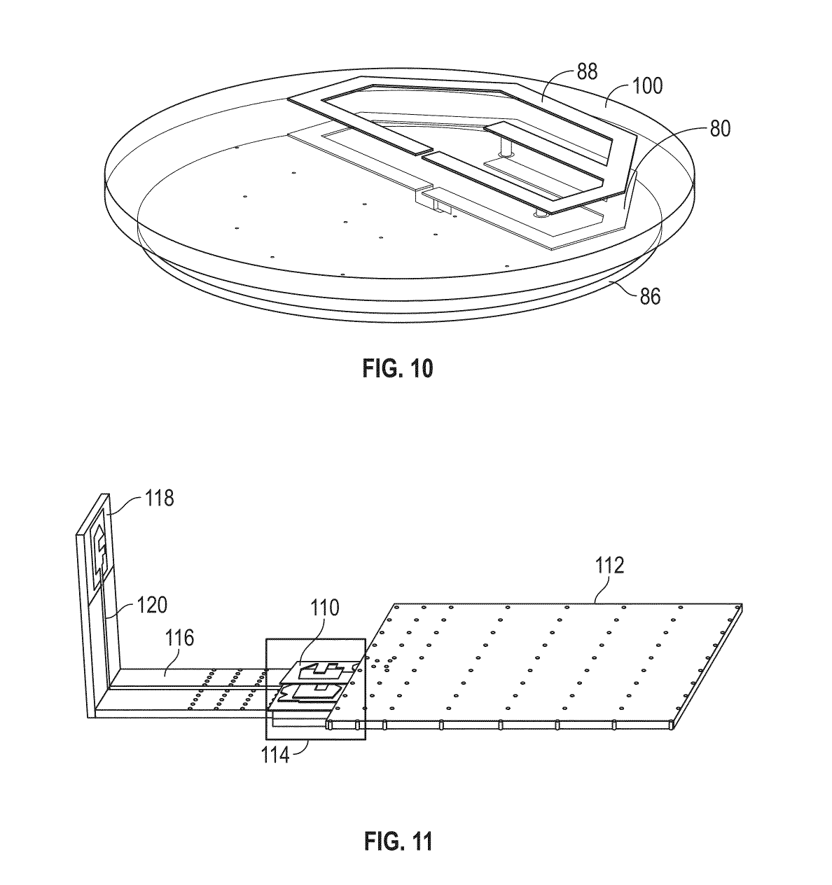

A full wave CPL antenna to a full wave CPL antenna compound coupling is illustrated with respect to FIGS. 8, 9 and 10. FIG. 8 provides a top view of a full wave CPL antenna 80, having a radiator 82 and a loop 84, mounted on a finite shared ground plane 86. The common artwork of CPL antenna 80 may operate as an antenna or as a compound coupler. A perspective view showing two full wave CPL antennas 80 and 88 mounted in a compound coupling arrangement is illustrated in FIG. 9. The CPL antenna 80 may be mounted on the ground plan 86. The CPL antenna 88 would not be mounted on the ground plan 86 or in direct physical contact with CPL antenna 80, but may be indirectly connected through a medium such as the glass plate 100 of FIG. 10, or some other type of medium, including plastic, human tissue, and air to name a few. This type of arrangement may make it possible for both of the compound coupling antennas to be located within a single enclosure, but still operate in compound coupling mode. Alternatively, the glass plate 100 could be part of a structure within which CPL antenna 88 is mounted, or the glass plate 100 could be placed between the enclose structures of both compound coupling antennas. For example, referring back to FIG. 1, the glass plate 100 could be mounted within the lid 20 to the pit 13, with the PCB assembly 16 placed against a first side of the glass 100 on the inside of the pit 13 and re-radiator assembly 18 placed a second side of the glass 100 on the outside of the pit 13.

While the water meter pit example is one particularly appropriate example, the present disclosure is not limited to just that particular application and could be utilized in any application where it is useful to have two different assemblies in wireless communication, but located in close proximity to one another. For example, Wi-Fi enabled devices are often designed to lay flat for various industrial, design, and aesthetic reasons. For example, a 802.11 ac 5 GHz enabled Wi-Fi router may lay down flat on a desktop or table. The efficient propagation of radio waves from this flat lying device at 5 GHz is known in the field to be dependent on maximizing the vertical polarization (electric field polarization with respect to the earth) of the antenna system of the device. This performance requirement has led industry designers and manufacturers of such devices to utilize a certain type of antenna implementation: those that are separated from the main device printed circuit board (PCB), connected with cables to the PCB and mounted perpendicular to the PCB along the perimeter of the plastic housing. This antenna implementation is often referred to as off-board and is inherently more expensive than if an antenna solution were to be printed on the main PCB directly, in the same plane as the PCB. The cost of coax cable, connectors, and manual assembly processes of the off-board antennas drive the added expense. Printed or on-board antennas are far more cost effective however, when implemented at 5 GHz in a lying flat device, but the polarization is a mix of horizontal and vertical so the performance suffers.

FIG. 11 illustrates an embodiment of a compound coupling antenna and a re-radiator antenna that realizes both the cost benefits of printed antennas and the performance increase of predominately vertical polarization. A CPL antenna 110 is printed on the main PCB 112. A second CPL antenna 114 may be printed on a separate PCB assembly 116 from the main PCB 112, which can be formed from printed flex PCB or other known manufacturing techniques. A third antenna 118 may be physically connected to CPL antenna 114 by connector 120 and operate as the re-radiator. Antenna 110 and antenna 114 comprise the compound coupling structure and do not radiate. Antenna 118 may be another CPL antenna that re-radiates the RF energy in an optimal vertical polarization, but need not be a CPL and could be another type of antenna. Many other types of compound coupling antenna and re-radiator antenna implementations should be apparent to a person of ordinary skill in the art upon reading the present disclosure, and this disclosure is not limited to the just the embodiments disclosed herein.

It should be appreciated that orientations of the pair of compound coupling CPL antennas, as described above, are only given by way of example. To meet space and design limitations, or other requirements of implementations, the compound coupling CPL antennas may be oriented in a variety of ways relative to their surroundings. For example, in the example illustrated in FIGS. 1-7, the coupling CPL antennas are perpendicular to the re-radiating antenna. In other aspects contemplated herein, the coupling CPL antennas may be oriented in any manner and at any angle including parallel to the re-radiating antenna or overlapping the re-radiating antenna. Similarly, the examples described in reference to FIGS. 8-10 may be oriented differently, and so on, as long as the two coupling CPL antennas are parallel or substantially parallel to one another.

In a further embodiment, an additional CPL antenna structure may be added to an existing device that does not share the same reference ground with the other antenna(s) to which it is coupled. The device may be any type of device with a wireless antenna operating at any frequency, such as a phone handset, payment terminals, M2M devices, IoT devices, tablets, laptops, MIFI devices, GPS receivers, etc. The CPL antenna structure includes at least one CPL antenna and a support structure for holding the CPL antenna close or in proximity to the original antennas of the device. The support structure includes a second ground that is not connected to the first reference ground of the device. The CPL antennas of the CPL antenna structure do not require their own power source, but are rather powered through capacitive coupling with the original antennas of the device.

Once the CPL antenna is properly positioned relative to the original antenna, the CPL antenna will be capacitively coupled to the original antenna(s) of the device and energy radiated from the original antennas of the device, whether CPL or non-CPL, will be coupled to the CPL antenna so as to re-radiate that energy. This approach may induce characteristic compound electric and magnetic fields due to the structure of the CPL design, and higher gain with desired radiation patterns and polarization can be achieved. Reduced RF emission may also be achieved.

Due to the law of “conservation of energy,” in free space conditions, adding the CPL antenna as a re-radiator is not going to increase total radiated power of the original antenna, but by varying the radiation pattern and polarization, the re-radiator antenna can be more directional. In certain cases (e.g., a mobile phone being held in a user's hand) making the re-radiator antenna more directional (i.e., towards a desired direction) can improve the total radiated power level in that specific user case.

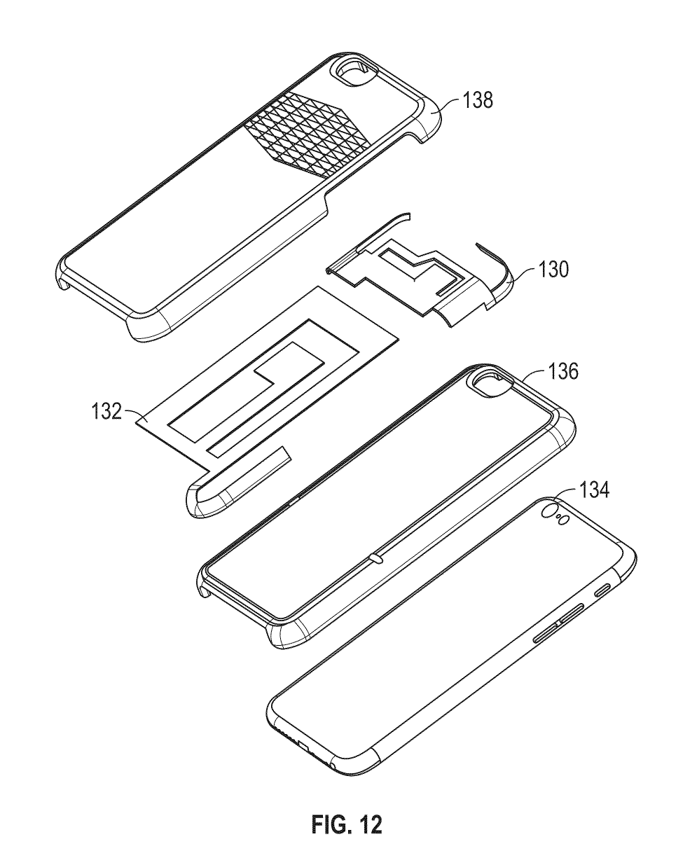

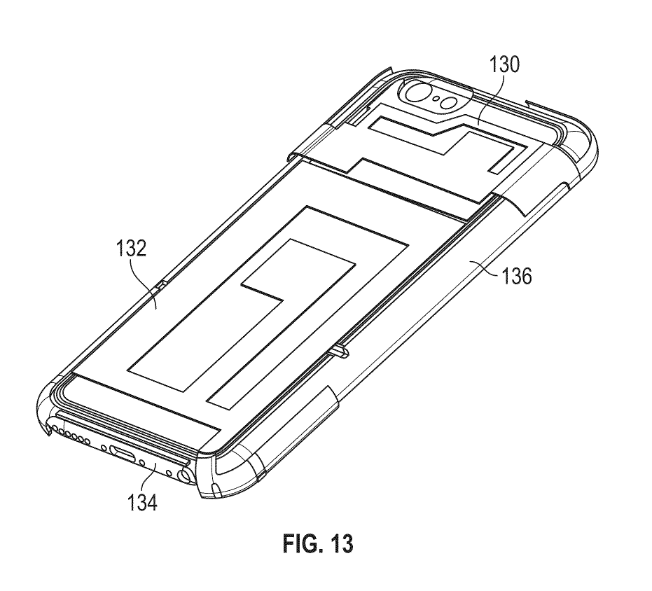

In an embodiment, the device is a smartphone and the re-radiating antenna(s) may be added to a case (e.g., a protection case) for the smartphone. For example, as illustrated in the exploded view of FIG. 12, two CPL antennas 130 and 132 are shown as being incorporated into a protection case for a smartphone 134 having an inner portion 136 and an outer portion 138. The CPL antennas 130 and 132 are illustrated in FIG. 12 as being sandwiched between the inner portion 136 and the outer portion 138 of the case in order to protect the CPL antennas 130 and 132 from damage and to isolate them from the first ground of the device. The case need not have inner and outer portions, however, so the CPL antennas 130 and 132 could be configured relative to the support structure of the case in alternative ways. FIG. 13 illustrates the two CPL antennas 130 and 132 applied to the inner portion 136 of the case, and without the outer portion 138 shown, in order to show the placement of the antennas 130 and 132 relative to the smartphone 134.

Antenna 130 may operate at a first frequency, such as 700 MHz, and antenna 132 may operate at a second frequency, such as 1700 MHz. As shown in FIGS. 12 and 13, the two CPL antennas 130 and 132 are not connected to one another and work independently, but other arrangements are possible. For example, CPL antennas 130 and 132 can be connected. In some situations, there may be a need to couple the CPL antennas in one or more locations in order to re-radiate power at different frequencies in the same or different directions, i.e., different arrangements and connections of the CPL antennas may serve to direct some RF surface currents at various frequencies onto the metallic areas of the CPL antennas 130 and 132 in order to achieve the desired amount of re-radiated energy and directionality.

By installing or placing a case including one or more CPL antennas onto a smartphone, the CPL antennas may be positioned close enough to the original antennas inside the smartphone to capacitively couple with the original antennas and to change the radiation pattern of the original antennas. As noted above, the location and other properties of the CPL antennas may be used to re-radiated energy from the original antennas in a designed way, such as improving the total radiated power (TRP) and total isotropic sensitivity (TIS) of the device, in general, or in some specific way, such as when the smartphone is being held in the right hand of the user.

The shape of the re-radiating CPL antennas may also be relevant to the amount of energy radiated in certain directions at certain frequencies. For example, the device to which the re-radiator antennas are being applied may include multiple antennas, such as a MIMO system that requires multiple original antennas to cover the same frequency range. Each of those original antennas induce electromagnetic fields in the vicinity of each antenna, but also all around the device itself. These fields add up or cancel each other based upon the phase and amplitude they have in each direction. The amount of RF energy (electromagnetic fields) radiated depends on whether the power sources of each antenna are ON simultaneously or not, sequentially ON or not, and possibly activated using a dynamic tuning system (behind each or both antennas). Under such circumstances, the shape and dimensions of the re-radiator antennas may be designed to accommodate the appropriate coupling to these given electromagnetic fields in order to generate the right amount of energy radiated in the wanted direction at the wanted amplitude, so as to enhance the general performance of the device. For example, the fair split of energy among the elements of the original antennas that are being coupled and re-radiated by the elements of the CPL antennas may vary between different designs of the CPL antennas. Some variances may generate better improvements to the low band and some variances may generate better improvements to the high band.

In addition, while two CPL antennas are shown in FIGS. 12 and 13, a single CPL antenna may be utilized and more than two CPL antennas may also be utilized, especially when the device includes multiple different antennas operating at numerous different frequencies. While other types of antennas with more traditional shapes could be utilized to re-radiate energy from the device, such as patches, slots, meanders, oblong shapes, etc., such solutions tend to end up with more selective, less broadband performance than is possible when a CPL antenna is utilized. CPL antennas, on the other hand, enable multi-protocol, wide band coupling for the device with which they are being used.

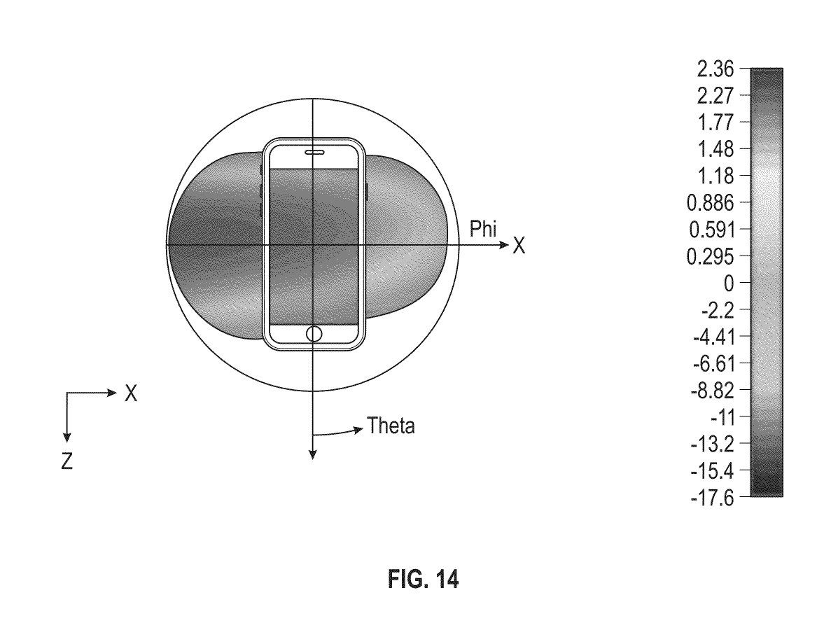

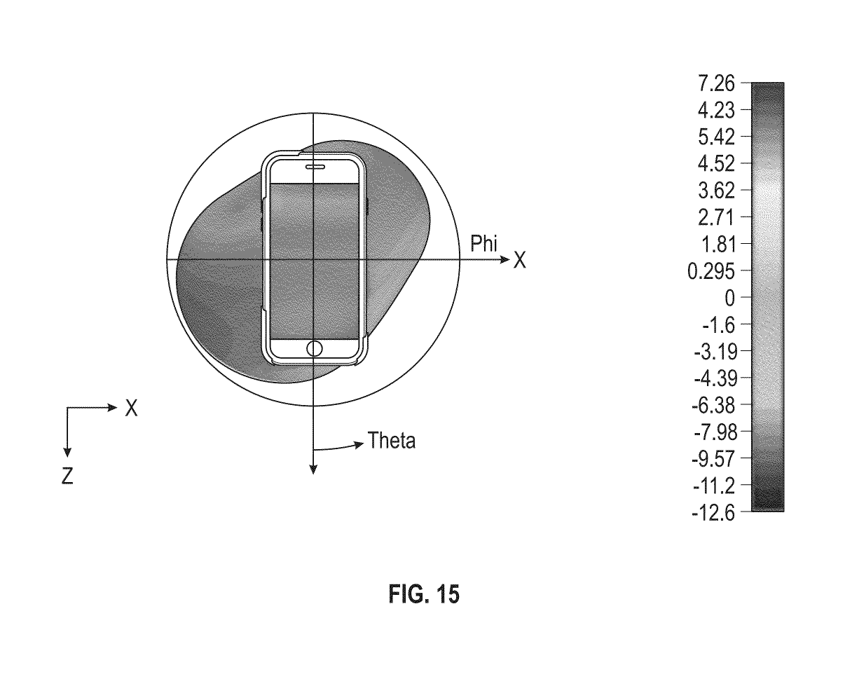

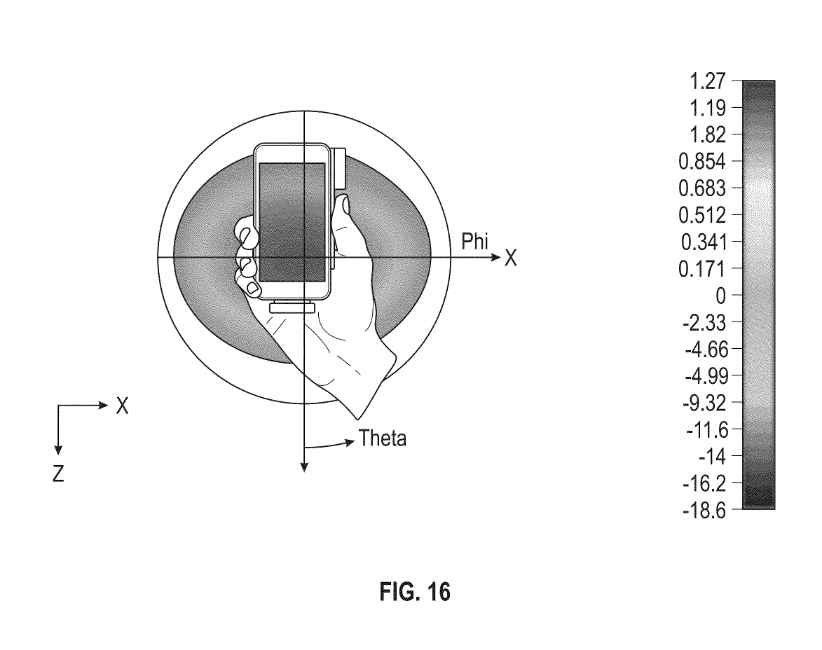

In particular, the relative performance of an embodiment, such as that shown in FIGS. 12 and 13, is described below in reference to FIGS. 14-20. FIG. 14 shows the free space 700 MHz radiation pattern of the original antenna(s) within a smartphone with no CPL antenna used to re-radiate that energy. In this example, the radiation pattern indicates that the radiation efficiency of the device is only about 0.07 dB, the total efficiency is about −3.52 dB and the gain is about 2.36. FIG. 15 shows the same smartphone with a case installed around it including one or more CPL antennas that re-radiate the energy of the original antennas. For example, one CPL antenna may be placed within the case (not visible within FIG. 16) to re-radiated energy from the original antenna(s) and/or one or more CPL antennas may be place on the case, such as one CPL antenna visible at the bottom of the case and a second CPL antenna visible just above the user's thumb. As illustrated in FIG. 15, the free space 700 MHz radiation pattern for the device, shown from the same angle, has changed significantly from that shown in FIG. 14 due to the CPL re-radiator, and the radiation efficiency of the device improves to about −3.57 dB, the total efficiency increases to about −14.52 dB, and gain increases to 7.24 dB.

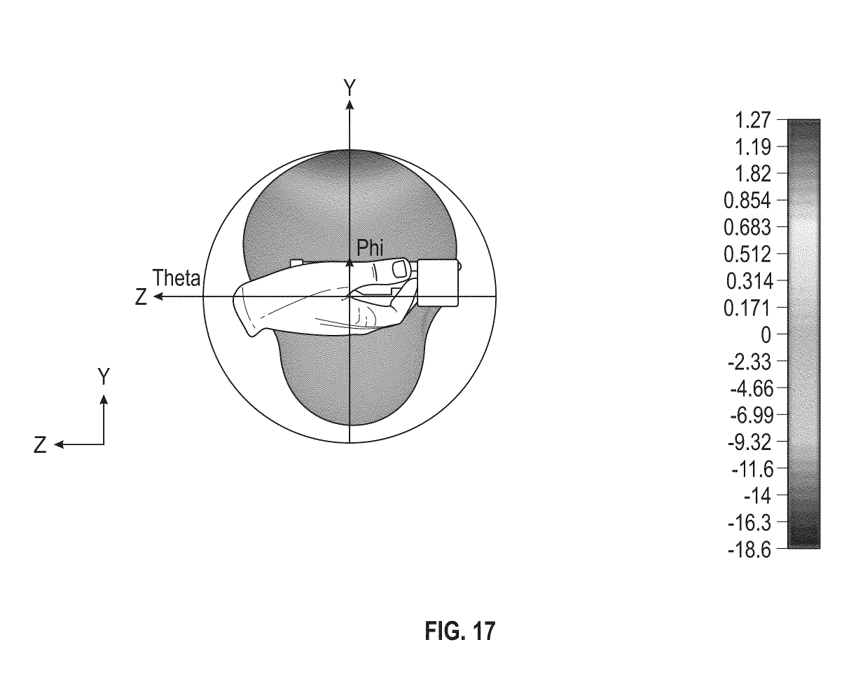

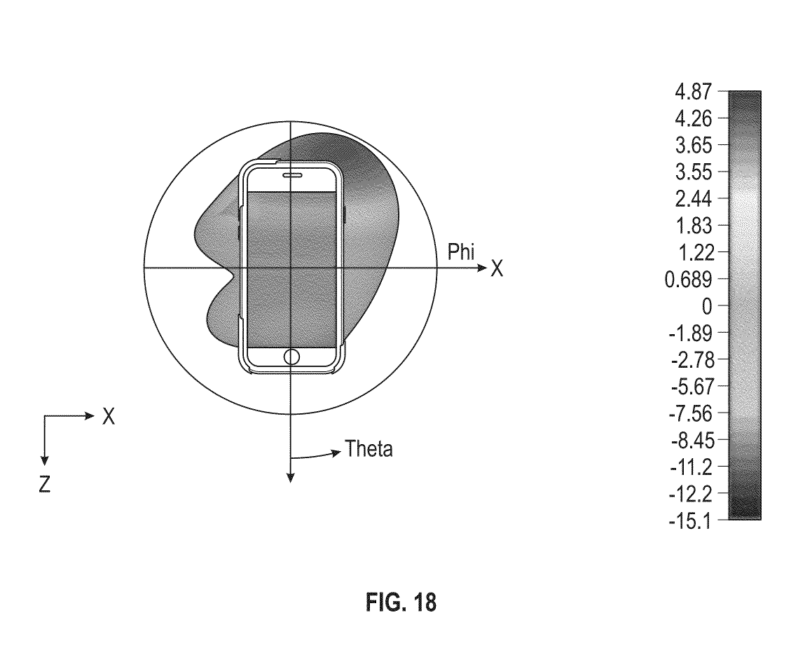

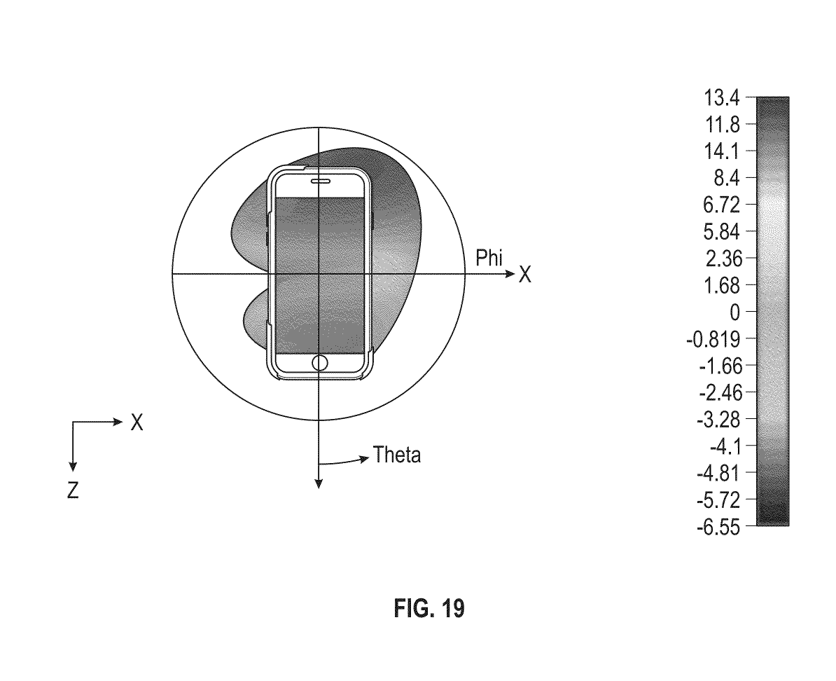

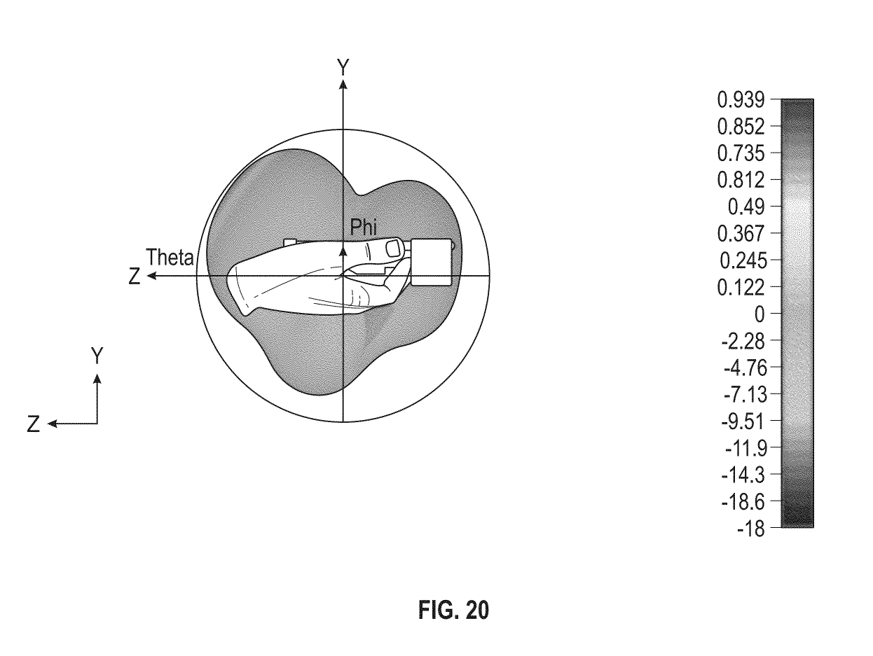

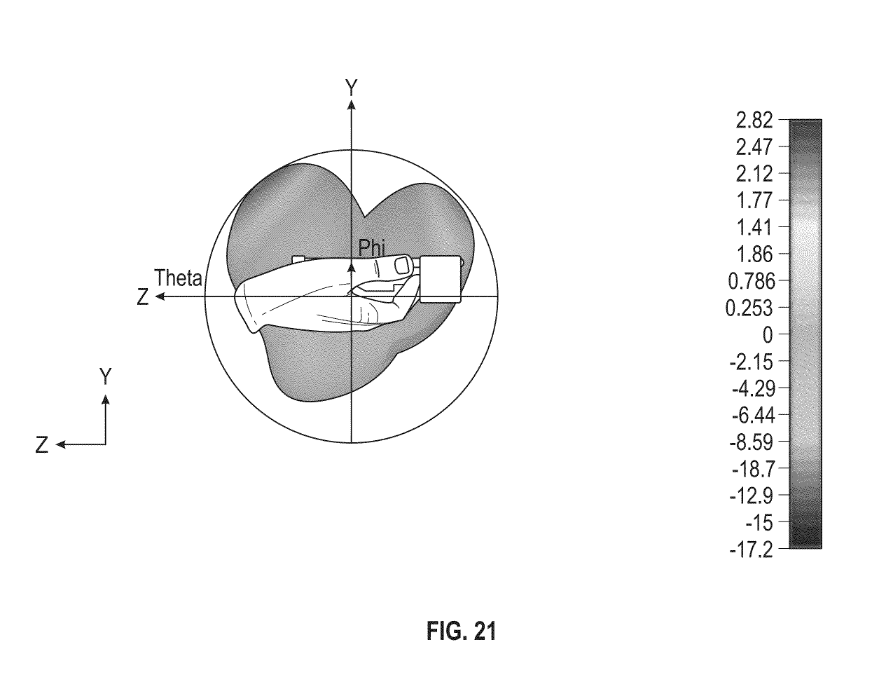

As previously noted, the CPL re-radiator can be designed to optimize performance of the radiation pattern of the device generally, as shown by FIG. 15, or specifically. For example, the particular design illustrated in FIGS. 12 and 13 optimizes the radiation pattern when the smartphone is being held in the user's right hand. This optimization is further illustrated in FIGS. 16 and 17, which show that when the phone is held in the user's right hand, the radiation efficiency of the device is about −3.68 dB, the total efficiency is about −5.27 dB, and the gain is about 1.37, and while the radiation efficiency and gain are lower than when the device is in free space, the efficiency is still considerably higher than possible with just the device's original antennas. In addition, the directionality of the radiation pattern is also shifted so that the radiation pattern is specifically shaped to optimize operation of the device. FIG. 16 shows the 700 MHz radiation pattern when the device is being held in the user's right hand, while FIG. 17 shows the same pattern from a side view. FIGS. 18-21 show the same device at 1700 MHz, with the device shown in free space without the CPL re-radiator in FIG. 18, the device shown with the CPL re-radiator in FIG. 19, the device without the CPL re-radiator being held in the user's right hand in FIG. 20, and the device with the CPL re-radiator being held in the user's right hand in FIG. 21. The radiation pattern illustrated in FIG. 18 is substantially the same as that illustrated in FIG. 19, but the performance of the device increased by about 3.5 dB in total efficiency in the radiation pattern of FIG. 19. Likewise, the addition of the re-radiator structure to the device increased the total efficiency of the device from FIG. 20 to FIG. 21 by about 3.9 dB, and altered the radiation pattern as well.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope the disclosures herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the disclosures herein. The accompanying claims and their equivalents are intended to cover such forms or modifications as would fall within the scope and spirit of certain of the disclosures herein.

What is claimed:

1. A re-radiating antenna structure, comprising:
a first compound loop antenna including at least a first radiator element and a first loop element; and
a support structure for supporting and holding the first compound loop antenna in close proximity to, but without touching, an antenna within a device having a first ground for the antenna, the support structure including a second ground isolated from the first ground,
wherein placement of the first compound loop antenna by the support structure causes the antenna within the device to capacitively couple and to wirelessly receive and transmit data to and from the device through the first compound loop antenna, and wherein the first compound loop antenna re-transmits the data received from the antenna within the device.

2. The re-radiating antenna structure of claim 1, further comprising:
a third antenna located on or within the support structure, wherein the third antenna is coupled with the first compound loop antenna , and wherein the third antenna re-transmits the data received from the antenna within the device.

3. The re-radiating antenna structure of claim 2, wherein at least one of a position or an orientation of the third antenna within or on the support structure determines a directionality of a power radiated by the third antenna.

4. The re-radiating antenna structure of claim 3, wherein the at least one position or the at least one orientation of the third antenna within or on the support structure is selected to achieve the directionality of the power radiated by the third antenna based on an intended position or orientation of the device.

5. The re-radiating antenna structure of claim 4, wherein the intended position or orientation of the device comprises being held in a right hand or a left hand of a user.

6. The re-radiating antenna structure of claim 3, wherein the directionality of the power radiated by the third antenna is independently configurable from a second directionality of a second power radiated by the antenna within the device.

7. The re-radiating antenna structure of claim 2, wherein the third antenna is coupled via a transmission line to the first compound loop antenna.

8. The re-radiating antenna structure of claim 2, wherein the third antenna comprises a second compound loop antenna including at least a second radiator element and a second loop element.

9. The re-radiating antenna structure of claim 8, wherein the support structure comprises an inner portion and an outer portion, and wherein the first compound loop antenna and the second compound loop antenna are positioned between the inner portion and the outer portion.

10. The re-radiating antenna structure of claim 8, wherein the first compound loop antenna is configured to operate at a first frequency and the second compound loop antenna is configured to operate at a second frequency.

11. The re-radiating antenna structure of claim 8, wherein the first compound loop antenna is coupled to the second compound loop antenna at at least one point, wherein at least one of the at least one point of coupling or a relative position of the first compound loop antenna with respect to the second compound loop antenna is configurable to re-radiate power at at least one of different frequencies or different directions from the first compound loop antenna and the second compound loop antenna.

12. The re-radiating antenna structure of claim 8, wherein a position of the first compound loop antenna, a position of the second compound loop antenna, or at least one other property of the first compound loop antenna or the second compound loop antenna is configurable to improve at least one of a total radiated power (TRP) and a total isotropic sensitivity (TIS) of the device.

13. The re-radiating antenna structure of claim 8, wherein the antenna within the device comprises a multiple input multiple output (MIMO) system of multiple antennas, and wherein the first compound loop antenna is configured to couple with one or more of the multiple antennas simultaneously or sequentially to generate a radiation pattern.

14. The re-radiating antenna structure of claim 1, wherein the antenna within the device comprises a second compound loop antenna including at least a second radiator element and a second loop element.

15. The re-radiating antenna structure of claim 14, wherein the first compound loop antenna capacitively couples and inductively couples with the second compound loop antenna within the device.

16. The re-radiating antenna structure of claim 1, wherein the first compound loop antenna passively compound couples with the antenna within the device.

17. The re-radiating antenna structure of claim 1, wherein the first compound loop antenna is energized by the antenna within the device through capacitive coupling. The re-radiating antenna structure of claim 1, wherein the support structure comprises a smartphone case.

19. The re-radiating antenna structure of claim 1, wherein the device comprises any of a smartphone, a phone handset, a payment terminal, a M2M device, an Internet of Things (IoT) device, a tablet, a laptop, a MIFI device, or a GPS receiver.

20. The re-radiating antenna structure of claim 1, wherein the support structure further includes a second compound loop antenna in close proximity to, but without touching, the antenna within a device, the second compound loop antenna operating at a different frequency than the first compound loop antenna.
